(19) United States
(12) Patent Application Publication
(10) Pub. No.: US 2026/0189053 A1
(43) Pub. Date: Jul. 2, 2026

(54) GRID-FORMING EQUIPMENT FOR HOME BACKUP ENERGY MANAGEMENT

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US)

(21) Appl. No.: 19/230,263

(22) Filed: Jun. 6, 2025

Related U.S. Application Data
(60) Provisional application No. 63/739,980, filed on Dec. 30, 2024.

(51) Int. Cl. H02J 9/06; H02J 3/00

(52) U.S. Cl. CPC H02J 9/062; H02J 3/0012

(57) ABSTRACT

An energy management apparatus and method are disclosed for maintaining power delivery during grid outages. The system includes a grid-forming inverter electrically connected to a grid and an inverter via a distribution line. A controller activates the grid-forming inverter upon detecting a loss of grid power, prompting it to generate a grid-forming signal with a reference voltage and frequency.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to power management.

### BACKGROUND

A backup power source may provide backup power to a home and an electric vehicle when the grid becomes unavailable.

### SUMMARY

An apparatus includes a home energy management system with a grid-forming inverter connected to a grid and an inverter via a distribution line. A controller activates the grid-forming inverter when grid power is lost, causing it to generate a grid-forming signal. The inverter synchronizes to this signal and supplies power to the distribution line. The signal includes a reference voltage and frequency. The grid-forming inverter may be connected upstream of a relay tied to a neutral-forming transformer and can generate signals regardless of the relay's state. The system may include a housing that contains either or both the controller and the inverter. A battery, potentially a dark start type, may provide DC power to the inverter and can be housed with either the inverter or the controller. The inverter may be a photovoltaic or vehicle inverter.

A method includes activating a grid-forming inverter in a home energy management system when grid power is lost. The inverter uses power from a dark start battery to generate a grid-forming signal on a distribution line. After activation, a relay may be closed to engage a neutral-forming transformer. The method also includes deactivating the grid-forming inverter when grid power is restored.

A home energy system includes a grid-forming inverter connected to a photovoltaic system through a distribution line and a controller that activates the inverter when grid power is lost. The inverter generates a grid-forming signal, and the photovoltaic system synchronizes to it and supplies power to the line. The system may include a neutral-forming transformer that the controller engages during signal generation. A battery, possibly a dark start type, supplies DC power to the inverter.

### BRIEF DESCRIPTION OF THE DRAWINGS

FIG. 1 is a schematic diagram of a home energy system including a grid-forming inverter located inside the system housing, a dark start controller and battery also located inside the housing, and a grid-forming battery positioned externally in a separate enclosure.

FIG. 2 is a schematic diagram of an alternative embodiment in which the grid-forming inverter is connected upstream of a neutral-forming transformer relay.

FIG. 3A is a schematic diagram of an alternative embodiment in which the grid-forming inverter, grid-forming battery, dark start controller, and dark start battery are located within the main system housing.

FIG. 3B is a schematic diagram of another embodiment in which the grid-forming inverter, grid-forming battery, and dark start controller are co-located in a shared external enclosure.

FIG. 3C is a schematic diagram of another embodiment in which the grid-forming inverter, grid-forming battery, and dark start controller are contained within the system housing.

FIG. 4 is a schematic diagram of an electric vehicle including a grid-forming inverter.

FIG. 5A is a schematic diagram of an electric vehicle architecture in which both the AC charger and the grid-forming inverter are connected to the traction battery via dedicated DC/DC converters.

FIG. 5B is a schematic diagram of an electric vehicle architecture in which the grid-forming inverter draws power from a downstream point on the AC charger.

FIG. 5C is a schematic diagram of an electric vehicle architecture in which the grid-forming inverter is powered by an auxiliary low-voltage battery.

FIG. 5D is a schematic diagram of an electric vehicle architecture in which the DC/DC converter of the AC charger provides controlled power to both the charger inverter and the grid-forming inverter.

FIG. 6 is a schematic diagram of electric vehicle supply equipment including a grid-forming inverter.

FIG. 7A is a schematic diagram in which the grid-forming inverter and its battery are housed together in a dedicated external enclosure separate from the EVSE.

FIG. 7B is a schematic diagram in which the grid-forming inverter is integrated into the EVSE housing, while the associated battery is stored in an external enclosure.

FIG. 7C is a schematic diagram in which the grid-forming inverter is integrated into the EVSE housing and receives power from a combined grid-forming and dark start battery housed within a main controller enclosure.

FIG. 8 is a plot of AC waveforms on a distribution line.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A home energy system may include multiple energy-related components integrated to deliver power to a residence. These components may include a utility power connection, one or more distributed energy resources such as photovoltaic (PV) panels or a generator, a main service panel, and energy management interfaces for controlling or coordinating loads, storage, and charging functions. The system may also include an electric vehicle (EV) and a corresponding electric vehicle supply equipment (EVSE) to facilitate charging the EV's traction battery using power supplied by the home.

When grid power is available, the home energy system typically operates in a grid-connected mode. In this mode, the home draws energy from the utility grid through the main breaker panel. The utility grid delivers alternating current (AC) power to the home via a split-phase connection, which includes a first line conductor (L1), a second line conductor (L2), and a grounded neutral conductor. The voltage between L1 and neutral, or between L2 and neutral, is approximately 120 volts. The voltage between L1 and L2 is approximately 240 volts. Many home appliances and devices are configured to operate on 120V, while higher-power loads such as HVAC equipment, ovens, and EVSEs may use the full 240V between L1 and L2. The grid provides both the voltage and the frequency reference for these devices to operate. Inverters associated with PV systems or battery storage systems, for example, often rely on the presence of this reference to synchronize their output and connect to the home.

In grid-connected mode, the photovoltaic system may be coupled to the AC wiring of the home. The PV system includes a DC-generating panel array and one or more inverters, such as microinverters or string inverters. These inverters convert the DC output from the PV array into AC power that can be used by the home or exported to the grid.

Operation of the inverters is dependent upon the presence of a stable voltage and frequency waveform. When grid power is available, the inverters operate in a grid-following mode; i.e., they detect the grid's voltage and frequency and adjust their output to match. If the grid waveform disappears or becomes unstable, the PV inverters typically shut down automatically to comply with anti-islanding protocols.

The EVSE is likewise connected to the home's AC wiring. When the EV is plugged in, the EVSE negotiates charging with the vehicle via communication protocols. In grid-connected mode, the EVSE draws AC power from the home, converts it to DC, and supplies it to the EV's traction battery. This process may be managed by the EVSE itself or by a central home energy controller. The EVSE may also communicate with a utility demand response system or with PV system controllers to schedule charging based on available solar energy or time-of-use rates.

When grid power becomes unavailable, the system enters an islanded or off-grid mode. In this condition, the main breaker or a transfer relay may open, isolating the home from the utility grid. The voltage and frequency reference that was previously provided by the grid is no longer present. This loss affects grid-following components, such as PV inverters, which are unable to operate without a reference signal. Standard PV inverters are designed to shut down when the grid disappears in order to prevent back feeding onto the grid and to protect utility workers. As a result, the PV system typically ceases operation during a grid outage, even if sunlight is available.

To restore PV functionality and enable continued use of renewable energy during an outage, a grid-forming reference may be introduced as provided herein. A grid-forming inverter (also referred to herein as “GFI”) is capable of generating its own voltage and frequency signal. When energized, it outputs an AC waveform that mimics the grid, providing the synchronization needed for grid-following inverters to begin operating. In such a configuration, the grid-forming inverter acts as the virtual grid. Once the waveform is present, the PV inverter detects it and begins exporting AC power onto the home's electrical system. If an electric vehicle is present and connected, and if the energy balance permits, PV power may be used to charge the vehicle even during the grid outage. The reference signal from the grid-forming inverter should be stable and robust enough to support this coordinated operation.

In some cases, the system may further include a neutral-forming transformer. This transformer includes a center-tapped winding that produces a synthetic neutral when the grid is disconnected. When the associated relay is closed, the transformer establishes a grounded reference point between L1 and L2, enabling the delivery of 120V power to appliances that require a neutral connection. The transformer, in combination with the grid-forming inverter, allows for full support of 120V and 240V loads during islanded operation.

As discussed in greater detail herein, depending on implementation, the grid-forming inverter may be located in a dedicated enclosure, integrated with the EVSE, or within the EV itself.

The overall control of the system may be handled by a home energy management controller, or may be distributed across the EVSE, PV controller, and inverter logic. Control decisions may be based on available solar energy, the state of charge (SOC) of the EV, the presence of local loads, or user-configured priorities. Upon grid restoration, the system may detect the return of utility voltage and frequency and transition back to grid-connected mode. In this mode, the grid-forming inverter may deactivate or revert to standby.

The system architecture and components that enable this mode transition and coordinated off-grid operation will now be described with reference to the figures.

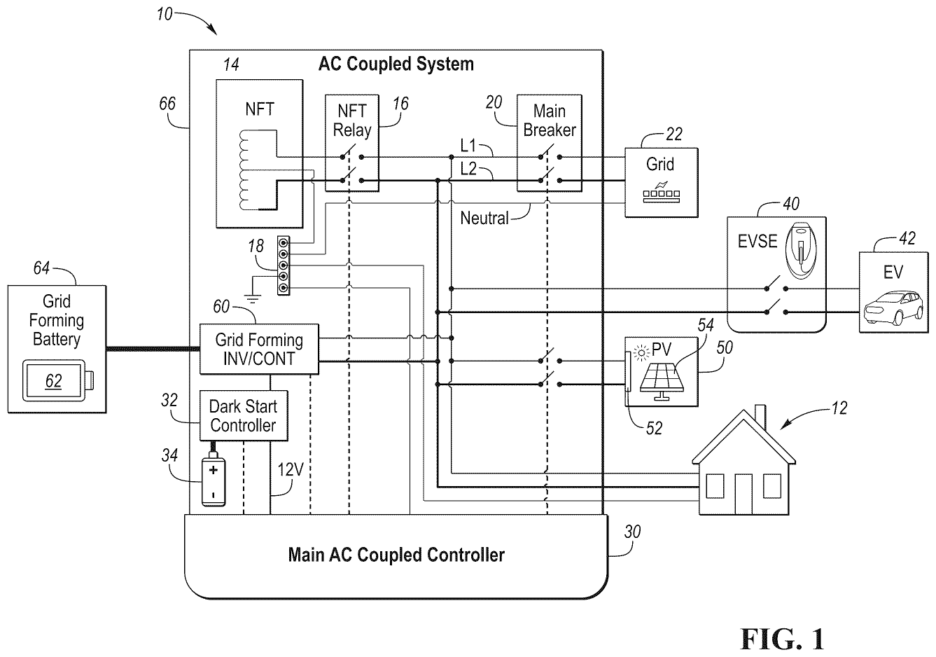

Referring to FIG. 1, an AC coupled system 10 of a home 12 includes multiple components that interact to support photovoltaic (PV) and electric vehicle (EV) operation during both grid-connected and grid-outage conditions. The system 10 includes a neutral-forming transformer (NFT) 14 that includes a winding (e.g., center-tapped) for producing a synthetic neutral. The NFT 14 is electrically connected to line conductors L1 and L2 and includes a switch labeled NFT relay 16. When the NFT relay 16 is closed, the NFT 14 connects to an AC bus 18 and creates a neutral reference between L1 and L2, enabling 120V split-phase operation during islanded mode.

The grid 22 supplies L1, L2, and Neutral lines to the system 10 under normal conditions. The system 10 includes a main breaker 20 that connects L1 and L2 to the home 12. When the grid 22 is present, the main breaker 20 is closed, allowing grid voltage and frequency to power the home 12 and synchronize grid-following inverters that are present within the system 10. When grid power is lost, the main breaker 20 opens, isolating the home 12 from the utility grid 22 and preventing back feeding.

The Neutral line is connected to the grounded center tap of the NFT 14 and to the neutral input from the grid 22. Within the system 10, the Neutral conductor runs to multiple components, including load centers and energy sources, providing a balanced voltage reference for 120V appliances.

The system 10 also includes a dark start controller 32 for managing a dark start battery 34. This battery 34 provides 12V DC power to control circuits during a blackout. A 12V line connects the dark start battery 34 to a main controller 30, which houses logic and relay control components. The dark start battery 34 allows startup of certain components such as relays and grid-forming logic even when grid voltage is absent. This enables the system 10 to initiate islanded operation automatically and autonomously.

The main controller 30 serves as a central coordination unit for relays, power sensing, inverter activation, and energy flow management. The main controller 30 connects to the NFT relay 16, the main breaker 20, the dark start battery 34, and the AC bus lines L1, L2, and Neutral. Through this controller 30, the system 10 manages transitions between grid-connected and islanded modes, and enables communication with other devices such as the PV inverter and EVSE described herein.

The main controller 30 of the system 10 may be implemented as a combiner box configured to house and interconnect a variety of electrical and control components associated with photovoltaic operation, electric vehicle interface coordination, and grid-forming inverter support. The combiner box structure may include an enclosed housing with pass-through or grommeted cable routing for accommodating L1, L2, Neutral, and ground conductors, along with low-voltage wiring for battery connections, control signals, and communications. The housing may be weatherproof, thermally managed, or segmented to separate high-voltage and low-voltage compartments, depending on system installation requirements. Internally, the combiner box may include terminal blocks, busbars, relays, fuses, or printed circuit boards configured to support interconnection and coordination of the components within system 10.

In the illustrated embodiment, the combiner box houses or is electrically connected to the dark start battery 34, the grid-forming inverter 60, and the NFT relay 16. The combiner box receives low-voltage power from the dark start battery 34 and may distribute that power to startup circuits associated with the grid-forming inverter 60 or other components such as inverter gate drivers, sensor conditioning electronics, or relay actuators. The combiner box may also receive DC power from the grid-forming battery 62, either directly or through high-current terminals routed into the enclosure. From the inverter 60, the combiner box delivers AC output power to the AC bus 18 via L1 and L2 conductors, and may provide wiring routes for the neutral conductor via connections to the neutral-forming transformer 14.

In some embodiments, the combiner box further includes circuitry for monitoring voltage and frequency conditions on the AC bus 18. This circuitry may support logic for detecting the presence or absence of the utility grid 22 and may signal the inverter 60 to enter or exit grid-forming mode. The combiner box may also include relay control logic to actuate the NFT relay 16 in coordination with islanded mode activation. For example, upon confirmation of a grid outage and energization of the grid-forming inverter 60, the controller 30 may initiate closure of the NFT relay 16 to activate the neutral-forming transformer 14 and establish a grounded neutral for split-phase operation. Conversely, during grid-connected conditions, the NFT relay 16 may remain open, and the combiner box may direct the inverter 60 to remain in a monitoring or passive state.

The combiner box may further serve as a central signaling and control hub, interfacing with other components in system 10. For example, the controller 30 may be communicatively connected to the EVSE 40 or PV inverter 52 to receive operational status, power availability, or charging readiness signals. In embodiments where vehicle state of charge (SOC) data is made available to the system, the combiner box may receive that information from the EVSE 40 and determine whether to enable or delay charging during grid outages. The combiner box may also coordinate energy flow logic by activating or deactivating system relays in response to changing PV output, vehicle connection status, or homeowner-specified operating modes.

While the combiner box described herein supports grid-forming inverter control and coordination, the structure of the box may also support modular expansion. Additional wiring harnesses, communication ports, or sensor inputs may be incorporated into the combiner box to accommodate new system features or alternative inverter topologies. In some embodiments, the combiner box may support hot-swappable components, include removable fusing or surge protection modules, or incorporate diagnostic indicators. The combiner box may be installed as a standalone enclosure or co-located with other components such as the grid-forming inverter 60, depending on system integration requirements and physical space constraints.

In addition to the home 12 and the grid 22, the system 10 is connected to electric vehicle supply equipment (EVSE) 40 for connecting to an electric vehicle (EV) 42. The EVSE 40 may be mounted on an interior or exterior wall of the home 12 and is electrically connected to the AC bus 18 through which it receives AC power for use in charging operations. The EVSE 40 is configured to deliver power to the EV 42 when plugged in, and may support bidirectional communication or control signaling with the EV 42 to negotiate charging parameters or exchange state information. The EVSE 40 may include internal power electronics and control logic for managing power delivery, initiating charging, or coordinating its behavior with other components of the system 10.

The EV 42 may include a traction battery configured to store energy for vehicle propulsion and other vehicle functions. When connected to the EVSE 40, the traction battery may receive AC-sourced charging power that is converted into controlled DC power by onboard electronics. As described herein, one or both of the EVSE 40 and the EV 42 may include a grid-forming inverter for use during grid outages.

The system 10 is electrically connected to a grid-following device, such as a photovoltaic (PV) system 50. In other embodiments, the system 10 may additionally or alternatively be connected to other grid-following equipment, including but not limited to energy storage systems, microinverters, fuel cell systems, wind turbine inverters, or other AC-coupled generation sources that rely on an externally provided voltage and frequency reference.

The PV system 50 includes a PV inverter 52 and a PV array 54. The PV array 54 includes one or more photovoltaic modules configured to convert sunlight into direct current (DC) electricity. The modules may be electrically connected in series, in parallel, or in a hybrid arrangement to achieve the desired voltage and current characteristics at the array output. The PV array 54 is electrically connected to the PV inverter 52, which converts the DC output of the PV array 54 into alternating current (AC) suitable for delivery to the AC bus 18. The PV inverter 52 may be implemented as a central inverter, string inverter, or distributed inverter system. In the illustrated embodiment, the PV inverter 52 is configured to deliver AC power across conductors L1 and L2 and, where present, may rely on a neutral reference to support 120V split-phase operation for certain downstream loads.

Under normal grid-connected operation, the PV inverter 52 receives an externally generated AC voltage and frequency reference from the utility grid 22. The PV inverter 52 synchronizes its output to match the grid waveform and provides current onto the AC bus 18. The PV-generated AC power may be consumed locally by the home 12, delivered to the EVSE 40 for charging the EV 42, or exported to the grid 22 when permitted. Because the grid 22 provides a stable reference waveform and a grounded neutral, the PV inverter 52 is able to support both 240V and 120V operation across L1, L2, and Neutral. In this mode, the NFT 14 remains inactive, with the NFT relay 16 in an open state, as the grid itself supplies the required neutral reference.

When the grid 22 becomes unavailable, the main breaker 20 opens and the system 10 transitions to islanded operation. In this state, the AC bus 18 no longer receives a voltage and frequency reference from the grid. As a result, the PV inverter 52 is unable to synchronize its output and automatically ceases operation—even if the PV array 54 is exposed to sunlight and generating DC power. To restore PV operation under these conditions, a grid-forming inverter—such as a grid-forming inverter 60 of the system 10, a grid-forming inverter 76 of the EV 42, or a grid-forming inverter 92 of the EVSE 40—may be activated to provide an AC voltage and frequency reference across L1 and L2. In embodiments supporting 120V loads, the NFT relay 16 may also be closed to activate the NFT 14, which generates a grounded neutral reference between L1 and L2. The combined presence of the grid-forming AC waveform and a neutral reference allows the PV inverter 52 to resume operation during the grid outage, enabling PV-generated energy to be utilized within the home 12 or directed to the EV 42 via the EVSE 40.

Upon loss of grid power, the main breaker 20 opens, isolating the home 12 and connected energy systems from the grid 22. This isolation prevents unintentional back feeding into the grid 22. Once isolated, the system 10 enters an islanded or off-grid mode. In this state, the AC bus 18 lacks a voltage and frequency reference, and grid-following components such as the PV inverter 52 are unable to operate. As a result, even though sunlight may be available and the PV system 50 is otherwise capable of producing energy, the PV inverter 52 will shut down. Similarly, the EVSE 40 may be unable to initiate or continue charging of the EV 42, due to the absence of a synchronized AC waveform.

To address the lack of voltage reference, a grid-forming inverter may be incorporated into the system 10. Unlike grid-following inverters, a grid-forming inverter is capable of generating its own AC output waveform, establishing both voltage magnitude and frequency without requiring an external reference. When activated, the grid-forming inverter energizes the AC bus 18 with a stable signal that enables downstream devices such as the PV inverter 52 and EVSE 40 to resume or continue operation during grid outages. In this way, the grid-forming inverter enables PV (or other) energy to be harvested and used locally, even when the utility grid 22 is offline.

In the illustrated embodiment, the system 10 includes a grid-forming inverter 60 electrically connected to the AC bus 18 and configured to generate a reference voltage and frequency signal during periods when grid power is unavailable. The inverter 60 may also be referred to as a grid-forming controller in embodiments where inverter functionality is combined with decision-making and control logic. The inverter 60 is electrically connected to a grid-forming battery 62, which provides a high-voltage DC power source for AC waveform generation. In certain embodiments, the inverter 60 also interfaces with the dark start battery 34, allowing the inverter 60 to be energized under low-power startup conditions when the grid-forming battery 62 is not yet available or remains isolated by contactors.

The grid-forming inverter 60 may include a power electronics stage such as an H-bridge or full-bridge converter, switching devices such as IGBTs or MOSFETs, and associated gate drive and filtering circuitry to produce an AC waveform. The inverter 60 may also include voltage sensing, current sensing, and control loop feedback circuits to control output voltage magnitude, frequency, and phase. In embodiments where the inverter 60 functions as a grid-forming controller, it may further include an onboard processor, memory, communication interface circuitry, and software or firmware routines for interpreting system conditions and executing control actions. The inverter 60 may include its own enclosure or be integrated within a larger housing associated with the system 10. In some implementations, either or both of the inverter 60 and the battery 62 may be mounted externally from the enclosure of the main controller 30 or the AC coupled system 10; for example, depending on system layout and thermal management considerations.

During normal operation when the grid 22 is available, the inverter 60 may remain in an inactive or standby state. The AC bus 18 receives its reference waveform directly from the grid 22 via the main breaker 20, and the PV inverter 52 operates in a conventional grid-following mode. The inverter 60 may monitor line voltage on L1 and L2 through internal sensors or through communication with the main controller 30. In some embodiments, the inverter 60 continuously monitors the voltage waveform, frequency, and phase angle of the grid 22. When these parameters fall outside of expected ranges or drop out entirely, the inverter 60 may interpret such conditions as a loss-of-grid event. Alternatively, the main controller 30 may perform this analysis and send a control signal to the inverter 60 to indicate a grid outage. Upon detection or notification of a loss of grid power, the inverter 60 initiates a grid-forming startup sequence.

In one embodiment, the inverter 60 is powered primarily or exclusively by the grid-forming battery 62. Upon detection of a grid outage, the inverter 60 may transition from a standby or monitoring state to an active grid-forming state using power received from the battery 62. The inverter 60 may include internal logic to evaluate readiness conditions prior to enabling its main power stage, such as confirmation of system isolation from the grid 22, expected voltage levels on the battery 62, and compatibility with downstream loads. Once these preconditions are met, the inverter 60 may begin generating an AC output waveform to energize the AC bus 18 and support operation of the PV system 50 and/or EVSE 40.

In another embodiment, the inverter 60 is also connected to the dark start battery 34, which may be used to activate inverter control circuitry when the grid-forming battery 62 is not immediately available. In this case, the inverter 60 may draw low-voltage DC power from the dark start battery 34 to energize logic components, gate drivers, or startup diagnostic routines. The grid-forming battery 62 may remain isolated by internal contactors or battery management system constraints until such logic is ready. Once internal readiness conditions are satisfied—such as verification of PV availability, EV load presence, or required voltage thresholds—the inverter 60 may initiate a controlled connection to the grid-forming battery 62 and begin power conversion. The dark start battery 34 may serve as a brief or limited source of auxiliary power, sufficient to support inverter startup sequences or fault recovery events when the grid-forming battery 62 is unavailable or requires delayed activation.

Once energized, the inverter 60 generates an AC output waveform across L1 and L2 on the AC bus 18. This waveform serves as a substitute for the utility grid and is used by grid-following devices—including the PV inverter 52 and the EVSE 40—to initiate or resume operation. In some embodiments, the inverter 60 may further close or command closure of the NFT relay 16 to activate the neutral-forming transformer 14. The combination of the inverter-generated waveform and the synthetic neutral from NFT 14 enables 120V and 240V split-phase operation for loads within the home 12. The main controller 30 may oversee coordination between the inverter 60 and the NFT 14 so that both components operate in concert when islanded conditions are active.

In this grid-forming mode, the inverter 60 enables the PV system 50 to synchronize and deliver AC power to the AC bus 18. This energy may then be used to power home loads, routed to the EVSE 40, or stored in the EV 42. The main controller 30 or inverter 60 may determine whether to permit charging of the EV 42 based on operating conditions such as PV output levels, home load demands, or the state of charge (SOC) of the EV traction battery 70. In one embodiment, the system 10 receives SOC information from the vehicle controller 82 and delays EV charging unless the SOC is below a predefined threshold, thereby prioritizing home loads. In another embodiment, charging is enabled only if the PV system 50 is producing excess power beyond home consumption. The inverter 60 may also vary its own output characteristics to match expected PV inverter sync behavior, such as by generating a sinusoidal waveform with a particular ramp-up profile to allow smooth PV reconnection.

In some configurations, the inverter 60 may further support communications with other components of the system 10. This may include serial, Ethernet, or wireless interfaces to the main controller 30, the EVSE controller 98, or external monitoring systems. The inverter 60 may report voltage, current, and frequency data; log fault events; or receive override signals from upstream control logic. The inverter 60 may also participate in sequencing logic during grid reconnection. When the main controller 30 detects that utility grid power has been restored, it may notify the inverter 60 to disengage from grid-forming mode. The inverter 60 may then ramp down its output, reopen internal contactors, or revert to a monitoring state. Depending on implementation, the inverter 60 may also support black-start or restart logic to prepare for subsequent outages without requiring manual intervention.

In one embodiment, shown in FIG. 1, the grid-forming inverter 60 is electrically connected to the AC bus 18 at a point downstream of the neutral-forming transformer (NFT) 14 and its associated relay 16. In this configuration, the output terminals of the inverter 60 are electrically coupled directly to the L1 and L2 conductors of the AC bus 18, while the neutral connection for split-phase operation is established only if the NFT relay 16 is closed. This configuration requires that the NFT relay 16 be in a closed state before the inverter 60 can supply voltage and frequency to the AC bus 18. If the NFT relay 16 is open, the inverter 60 is electrically disconnected from the neutral leg of the system and may not be able to generate or stabilize the AC waveform required to support downstream loads or synchronize the PV inverter 52. In this arrangement, inverter startup and grid-forming operation are inherently dependent on activation of the NFT 14 and closure of the relay 16. This configuration may be preferred in systems where the inverter 60 and NFT 14 are managed together by a common controller (e.g., controller 30), or where coordinated startup sequencing is desirable for intentional system design logic. For example, this configuration may be advantageous when it is preferred that no energized voltage appear on the AC bus 18 until the full split-phase architecture—including the neutral—is active and ready to support downstream appliances or inverter synchronization.

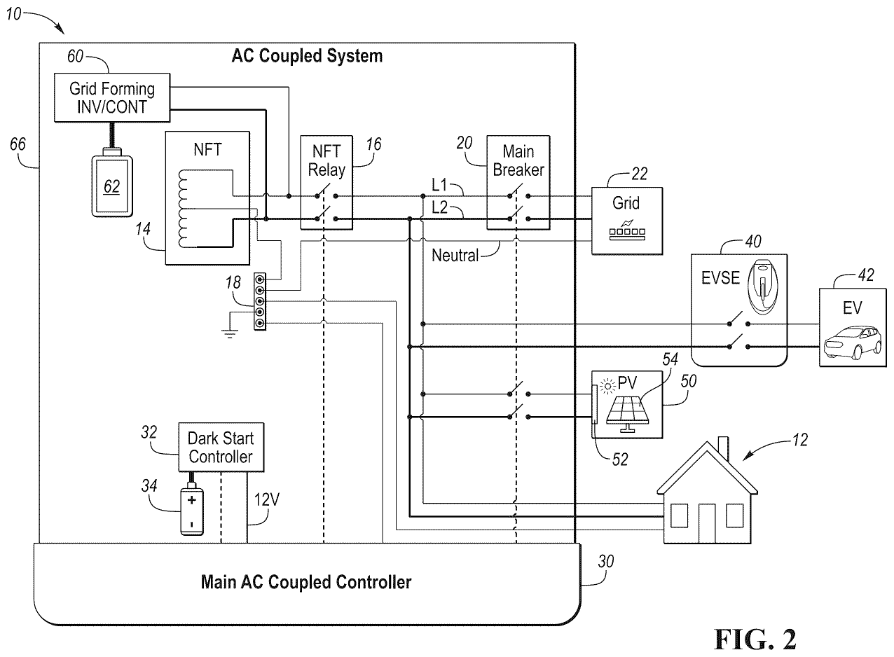

Referring to FIG. 2, in another embodiment, the grid-forming inverter 60 is connected upstream of the NFT relay 16, at a location electrically closer to the transformer winding of the NFT 14. In this configuration, the inverter 60 is wired to the L1 and L2 conductors on the source side of the NFT relay 16, allowing it to begin generating an AC waveform immediately upon activation, even if the NFT relay 16 remains open. This configuration decouples inverter activation from the relay state and enables the inverter 60 to start forming a voltage and frequency reference that can later be distributed to the AC bus 18 once the NFT relay 16 is closed. This setup may allow the inverter 60 to energize the upstream side of the system and verify operating stability before the neutral-forming relay is engaged. This configuration may be advantageous in systems where it is desirable to initiate grid-forming behavior early in the startup sequence—for example, to enable inverter diagnostics, detect PV availability, or validate conditions before committing to islanded operation. Additionally, this configuration may provide more flexibility in handling delayed or staged NFT relay engagement, or may be required in designs where the NFT relay is managed independently of the inverter control loop.

Referring again to FIG. 1, the grid-forming inverter 60 is shown physically located within a housing of the system 10. The inverter 60 is electrically connected to the AC bus 18 and is configured to provide a reference voltage and frequency to support operation of the PV system 50 and charging of the EV 42 during a grid outage. The inverter 60 may be located in the same compartment as the dark start controller 32 and dark start battery 34, or in a separate location within the system 10. In some versions of this embodiment, the inverter 60 is electrically coupled to the dark start controller 32, which manages startup logic, sequencing, and low-voltage energization for control electronics within the inverter 60. In other versions, the inverter 60 and the dark start controller 32 are separated within the system 10, with coordination handled via internal signaling lines.

The grid-forming battery 62 is located external to the system 10 and may be enclosed within a separate enclosure 64. This external placement may be beneficial in scenarios where the battery requires increased thermal management, or where system retrofitting constraints prevent inclusion of the battery 62 inside the existing housing. An external grid-forming battery 62 may also allow for modular or field-replaceable configurations, such that battery capacity can be upgraded or swapped independently of the system 10. The inverter 60 may be connected to the battery 62 via a high-voltage DC link and may receive startup or operating commands from the controller 30 during grid-outage conditions.

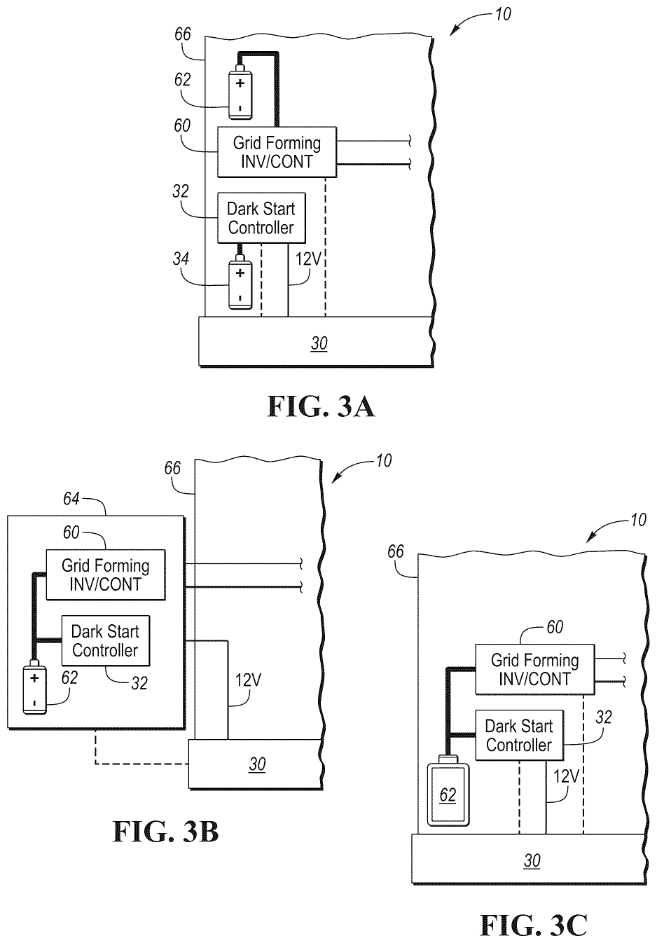

Referring to FIG. 3A, in another embodiment, the grid-forming inverter 60, grid-forming battery 62, dark start controller 32, and dark start battery 34 are all housed within the system 10. This configuration provides a fully integrated solution in which all core components related to grid-forming behavior are contained in a common enclosure, indicated at 66. Such integration may be advantageous in original equipment installations, where internal space and cooling provisions are designed to accommodate the full assembly. The internal location of the grid-forming battery 62 may simplify wiring, minimize external connections, and enable tighter coupling between the inverter 60 and the main controller 30. This arrangement may also reduce installation complexity and may be suitable for residential energy systems designed to operate as a self-contained backup solution.

Referring to FIG. 3B, in yet another embodiment, the grid-forming inverter 60, the grid-forming battery 62, and the dark start controller 32 are located outside of the system 10 and are housed together in a shared external enclosure 64. In this configuration, the grid-forming battery 62 supplies both the high-voltage DC power needed for inverter operation and a low-voltage supply for dark start control logic. The dark start controller 32 draws 12V power from the battery 62 to energize startup components and manage grid-outage detection and inverter activation sequencing. The inverter 60 is connected to the AC bus 18 and may begin supplying a reference voltage when activated by the main controller 30. This architecture may be advantageous where physical separation is required—such as for utility access, battery isolation, code needs, or where system 10 is space-constrained. A shared external enclosure 64 may also be used in retrofit or modular deployments where inverter upgrades or battery expansions are performed independent of the main system 10.

Referring to FIG. 3C, in another embodiment, the grid-forming inverter 60, the grid-forming battery 62, and the dark start controller 32 are located within the system 10. In this configuration, the battery 62 provides both high-voltage DC for inverter operation and low-voltage DC for dark start functionality. The main controller 30 manages grid-status detection, inverter startup logic, and relay sequencing during transitions between grid-connected and islanded operation. This arrangement may be suitable for new installations or factory-integrated systems where thermal management, shielding, and power coordination are designed as part of an integrated system architecture. Internal integration of all core components minimizes external interconnect complexity, enables tighter power bus coupling, and may reduce electromagnetic interference by shortening conductor paths.

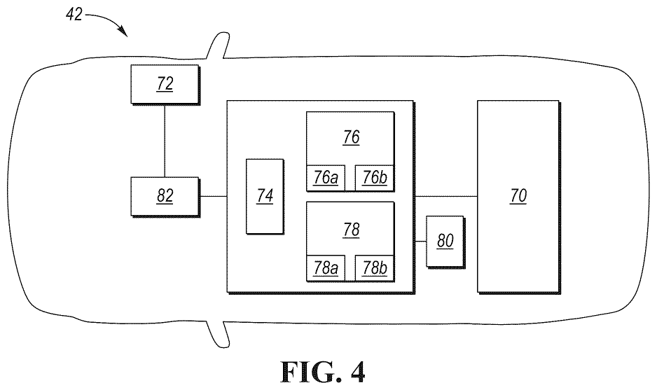

Referring to FIG. 4, the electric vehicle (EV) 42 includes a traction battery 70, a vehicle charging interface 72, a battery charge control module (BCCM) 74, and a grid-forming inverter 76. The traction battery 70 stores DC energy used to propel the EV 42 and to power onboard accessories. In some embodiments, the traction battery 70 may also serve as the energy source for the grid-forming inverter 76 integrated within the EV 42.

The vehicle charging interface 72 provides the physical and electrical connection between the EV 42 and the EVSE 40. In the illustrated embodiment, the interface 72 is configured to support bidirectional power transfer, such that the EV 42 may either receive AC charging power from the EVSE 40 or deliver grid-forming AC power to the EVSE 40 during a grid outage. The interface 72 may include signaling paths for exchanging charge control information, vehicle status, and grid availability indicators. In some embodiments, the interface 72 is further configured to carry synchronization signals that enable coordination between the grid-forming inverter 76 and components external to the vehicle, such as the PV inverter 52. The interface 72 may also serve as the control point for initiating activation of the grid-forming inverter 76 when the EV 42 is coupled to the EVSE 40 and islanded operation is required. In this way, the vehicle charging interface 72 enables the traction battery 70 and grid-forming inverter 76 to participate in home energy management functions without requiring modification to the home's fixed infrastructure. The vehicle charging interface 72 may be a combined charging system (CCS) port, J1772 connector, or other standardized or proprietary interface.

The traction battery 70 is connected to the BCCM 74, which manages battery charge state, monitors temperature, and controls energy flow into and out of the traction battery 70. The BCCM 74 includes or is connected to the grid-forming inverter 76. In addition to conventional battery management functions, the BCCM 74 may include logic for initiating islanded operation during a grid outage. The BCCM 74 may monitor the presence or absence of a voltage and frequency reference at the vehicle charging interface 72 and activate the grid-forming inverter 76 when grid power is unavailable and predefined operating conditions are satisfied. These conditions may include minimum state of charge thresholds, battery temperature range, or user authorization. In some embodiments, the BCCM 74 controls the direction of power flow through the grid-forming inverter 76, allowing energy to be exported from the traction battery 70 to the AC bus 18 or to be received from the PV system 50 and used to charge the traction battery 70. The BCCM 74 may also coordinate with the vehicle controller 82 to report inverter state, support load synchronization, and manage timing of transitions between grid-connected and islanded operation. In this way, the BCCM 74 supports both energy storage and active grid support functionality within a single integrated control platform.

The grid-forming inverter 76 may selectively activate during a grid outage or when the EV 42 is placed in a particular charging or backup mode. The inverter 76 converts DC power from the traction battery 70 into an AC signal that may be used to energize an AC bus (e.g., bus 18 of FIG. 1) or provide a reference voltage for operation of a PV inverter 52 or other grid-following devices.

The EV 42 further includes one or more contactors to isolate or couple the traction battery 70 to external circuitry through the vehicle charging interface 72. The contactors are switching devices configured to selectively couple or decouple the traction battery 70 from the vehicle charging interface 72. The contactors are controlled by a controller (e.g., vehicle controller 82 or the BCCM 74) and operate based on charging state, battery conditions, or external commands. When the EV 42 is connected to the EVSE 40 and charging is authorized, the contactors close to allow current to flow to or from the traction battery 70. In embodiments that include a grid-forming inverter 76, the contactors may also control whether the inverter 76 is electrically coupled to the charging interface or other vehicle circuitry.

The EV 42 may include a low-voltage battery 80 that supplies auxiliary power to control modules, contactors, sensors, and communications circuitry. The low-voltage battery 80 is typically a 12V or 48V source and may remain active independently of the traction battery 70. During grid outages or vehicle inactivity, the low-voltage battery 80 may provide the initial power required to operate the BCCM 74, activate the vehicle controller 82, or initiate startup of the grid-forming inverter 76. The availability of the low-voltage battery 80 allows selected vehicle systems to participate in backup energy coordination even when the traction battery 70 is not actively discharging or receiving charge. In some embodiments, the low-voltage battery 80 may also support pre-charge circuits or enable signaling across the vehicle charging interface 72 in preparation for islanded operation.

The vehicle controller 82 manages energy coordination functions between the EV 42 and external systems. The vehicle controller 82 may communicate with the EVSE 40 to negotiate charge parameters, transmit state of charge (SOC) data, and receive inverter-related control instructions. Communications may be conducted over analog signaling channels, such as control pilot (CP) and proximity pilot (PP) lines, or through digital communication protocols, such as power line communication (PLC), CAN, or wireless links. The vehicle controller 82 may also interface with the BCCM 74 to evaluate operating conditions and determine whether the grid-forming inverter 76 should be activated. These conditions may include SOC thresholds, traction battery availability, inverter demand from the EVSE 40 or main controller 30, and PV system 50 output status. In certain implementations, the vehicle controller 82 may further manage sequencing and timing during transitions between grid-connected and islanded operation, and may report operational readiness or inverter status to external controllers to support coordinated behavior across the system 10.

In the illustrated embodiment, the EV 42 includes an AC charger 78 configured to receive AC power from the EVSE 40 and convert it into DC power suitable for charging the traction battery 70. The AC charger 78 operates under the control of the BCCM 74, which may monitor battery parameters such as voltage, temperature, and state of charge to determine appropriate charging profiles. The AC charger 78 includes power electronics that manage voltage control, current limiting, and charge sequencing to deliver energy efficiently to the traction battery 70. During operation, the AC charger 78 may also interface with external components, such as the EVSE 40 or main controller 30, to receive charging enablement commands, communicate status information, or respond to coordination signals associated with PV output or system-level load conditions. In some embodiments, the AC charger 78 may further support power flow diagnostics, charge termination logic, or integrated protections for overvoltage, overcurrent, or thermal events.

The AC charger 78 includes a DC/DC converter 78a and a DC/AC inverter 78b. The AC charger 78 is configured to convert AC input power from the EVSE 40 into a controlled DC voltage suitable for charging the traction battery 70. The AC charger 78 may be implemented as a single integrated power electronics module or as two distinct stages operating under coordinated control. During charging operation, the AC charger 78 rectifies AC input power to produce a DC bus voltage and then controls that DC voltage to match the required charging profile of the traction battery 70. In some embodiments, the AC charger 78 is also capable of operating in a reverse power flow mode, enabling discharge of the traction battery 70 back through the charger for export to the AC line, such as during vehicle-to-grid (V2G), vehicle-to-home (V2H), or vehicle-to-load (V2L) events.

The DC/AC inverter 78b of the AC charger 78 is configured to perform the first stage of power conversion. During charging operation, the inverter 78b functions as an AC-to-DC rectifier that converts the AC voltage received from the EVSE 40 into an intermediate DC link voltage. The rectified DC output may be pulse-width modulated (PWM) or filtered using passive or active components to produce a stable DC bus. This DC bus is then supplied to the DC/DC converter 78a. In reverse operation, when power is to be exported from the traction battery 70, the DC/AC inverter 78b may operate in inverter mode, generating a synchronized AC waveform on the charging interface in coordination with grid-forming or grid-following logic. In this mode, inverter 78b may control voltage, current, and phase angle to match the utility or microgrid signal present on the AC bus 18.

The DC/DC converter 78a is configured to the DC link voltage and convert it to a voltage and current level appropriate for charging the traction battery 70. This may include step-down (buck), step-up (boost), or bidirectional buck-boost configurations, depending on battery architecture. The converter 78a may dynamically adjust its output based on battery SOC, temperature, and charger control commands received from the BCCM 74 or vehicle controller 82. During discharging operation, the converter 78a operates in reverse, drawing power from the traction battery 70 and controlling that power to provide a controlled DC link voltage to the inverter 78b. In this mode, converter 78a may also manage battery-side protections and enforce discharge limits or termination conditions. The coordinated control of converters 78a and 78b allows the AC charger 78 to act as a bidirectional interface between the traction battery 70 and the external AC power grid, supporting both energy intake and controlled export as part of an integrated home energy or grid-support strategy.

In embodiments where the EV 42 includes an onboard grid-forming inverter 76, the inverter 76 may be implemented as a separate power stage that also includes a DC/DC converter 76a and a DC/AC inverter 76b. The grid-forming inverter 76 is configured to convert DC energy from the traction battery 70 into an AC output waveform suitable for energizing the AC bus 18 during a grid outage. The output waveform may include a specified voltage magnitude and frequency (e.g., 240V RMS at 60 Hz) and is used as a reference signal for the PV inverter 52 and other grid-following components.

The DC/DC converter 76a is configured to condition the high-voltage output of the traction battery 70 and supply a controlled intermediate voltage to the DC/AC inverter 76b. This may involve voltage conversion, current limiting, and soft-start functionality. The DC/DC converter 76a may also isolate the traction battery 70 from high-frequency switching components to reduce conducted emissions or affect inverter efficiency.

The DC/AC inverter 76b is configured to generate a grid-forming AC signal on the vehicle-side terminals of the vehicle charging interface 72. The inverter 76b may operate in a standalone mode or in coordination with other inverters within system 10, such as grid-forming inverter 60 of the AC coupled system. The waveform produced by the inverter 76b is intended to serve as the master voltage and frequency reference for the islanded portion of the system 10 during grid outages. In certain embodiments, inverter 76b may support voltage droop control, phase lock loop synchronization, or other control techniques that facilitate operation in parallel with other inverters. The inverter 76b may be selectively enabled based on commands from the BCCM 74 or the vehicle controller 82, and may be deactivated when grid power is restored or when the SOC of the traction battery 70 falls below a predefined limit.

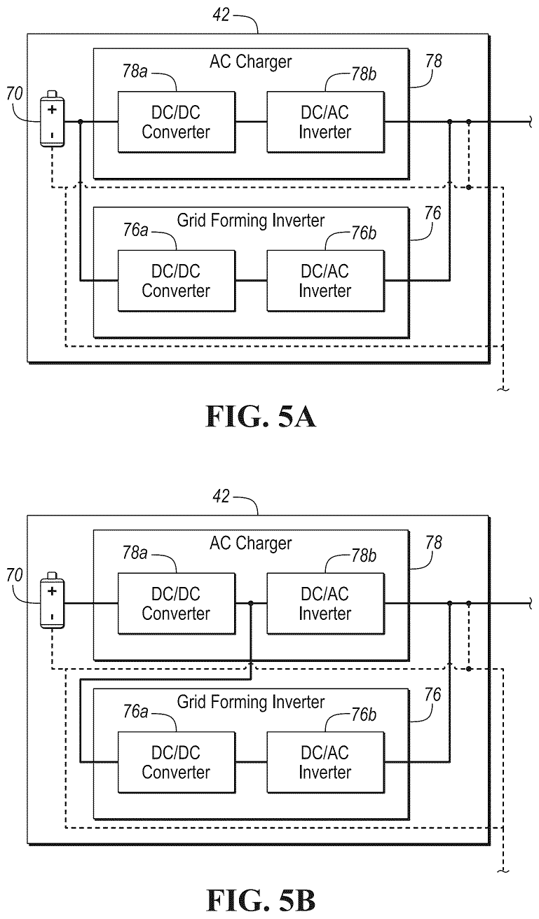

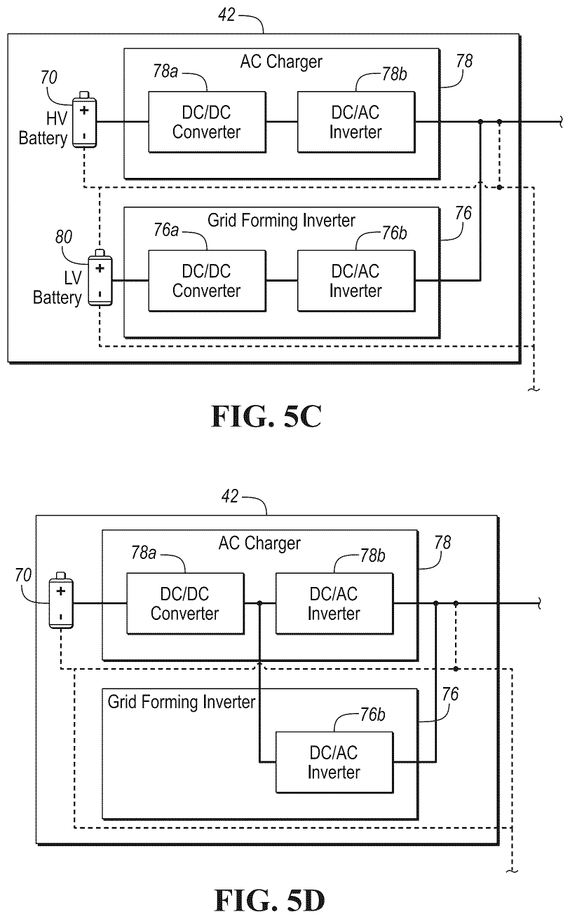

Referring to FIG. 5A, an embodiment of the EV 42 is shown in which both the AC charger 78 and the grid-forming inverter 76 are electrically connected to the traction battery 70. In particular, each of the DC/DC converters 78a and 76a draws DC power directly from the traction battery 70. This architecture enables the AC charger 78 and the grid-forming inverter 76 to operate independently, each with its own power conditioning stage. The DC/DC converters 78a and 76a may include hardware features suitable for managing high-voltage battery input, such as current-limiting components, reverse-polarity detection circuits, soft-start controllers, overvoltage clamps, and pre-charge circuitry for inrush current control. Isolated gate drivers, opto-isolated feedback channels, and thermal shutdown logic may also be incorporated to promote reliable operation. The use of independent power paths enables modular control of vehicle charging and grid-forming functions and may allow for asynchronous operation between the two subsystems.

Referring to FIG. 5B, another embodiment is shown in which the grid-forming inverter 76 receives power from the traction battery 70 via the AC charger 78. In this configuration, the DC/DC converter 78a of the AC charger 78 is electrically connected to the traction battery 70 and performs the primary control and protection functions required for interfacing with the high-voltage battery. The output of converter 78a is a conditioned DC voltage that is supplied to both the charger inverter 78b and to the DC/DC converter 76a of the grid-forming inverter 76. In this arrangement, converter 76a remains present within the grid-forming inverter 76, but is no longer required to handle raw battery voltage or full-featured input-side protections. As a result, converter 76a may be implemented using a smaller or lower-complexity design that provides local conditioning, filtering, or voltage matching for the downstream inverter stage 76b. This architecture enables a reduction in component duplication while still maintaining separate control of grid-forming and charging functions. Additional benefits may include reduced thermal footprint and simplified packaging in the implementation of the grid-forming inverter subsystem.

Referring to FIG. 5C, another embodiment is shown in which the grid-forming inverter 76 draws power from an auxiliary low-voltage battery 80, while the AC charger 78 remains connected to the traction battery 70. In this arrangement, the DC/DC converter 78a continues to control power delivery to the AC charger inverter 78b, and the traction battery 70 remains the primary energy source for powering and charging operations. The grid-forming inverter 76, however, receives its power input from a dedicated auxiliary source such as auxiliary battery 80. The auxiliary battery 80 may provide 12V or 48V nominal output and may be electrically isolated from the traction battery 70. This configuration allows the grid-forming inverter 76 to operate in isolation from the high-voltage bus, which may offer implementation advantages in applications requiring isolation or priority separation between grid-forming and propulsion subsystems. The use of the auxiliary battery 80 may also support rapid inverter activation or persistent availability during deep discharge of the traction battery 70.

Referring to FIG. 5D, a further embodiment is illustrated in which the DC/DC converter 76a of the grid-forming inverter 76 is omitted, and the converter 78a of the AC charger 78 is configured to provide controlled DC power to both the charger inverter 78b and the grid-forming inverter 76b. In this configuration, the DC output of converter 78a forms a shared DC link that supports both charging and grid-forming functions. The traction battery 70 is electrically connected to converter 78a, and the two inverter stages 78b and 76b receive their respective power inputs from a common DC node. This architecture may reduce component duplication, simplify power distribution, and minimize interconnection losses. Elimination of converter 76a may also reduce weight and volume within the EV 42 and may simplify thermal management. In some embodiments, converter 78a may be adapted to supply multiple output paths or incorporate switching logic to prioritize load delivery under specific system conditions.

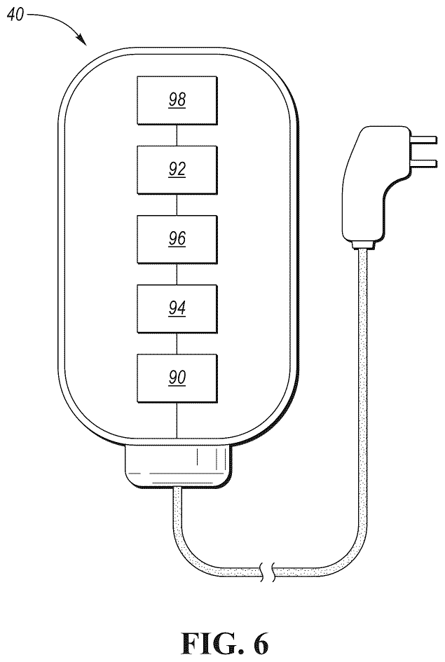

Referring to FIG. 6, the EVSE 40 includes a vehicle interface 90, a grid-forming inverter 92, a relay contactor 94, a power converter 96, an EVSE controller 98, and. The vehicle interface 90 connects to the vehicle charging interface 62 when the EV 42 is plugged in and may include an insertable plug portion configured to engage the vehicle charging interface, along with signaling or detection circuitry located within the plug or within the EVSE housing. The vehicle interface 90 supports bidirectional power transfer and signaling pathways used for charge negotiation and coordinated operation of the grid-forming inverter 76 or 82 during islanded mode. In some embodiments, the vehicle interface 90 includes proximity sensing, plug-in detection, and compatibility signaling used by the EVSE controller 98 to determine whether charging or grid-forming functions should be activated. The vehicle interface 90 may further serve as a gating condition for inverter activation, such that grid-forming behavior is enabled only when a valid vehicle connection is present and communication with the EV 42 has been established.

The grid-forming inverter 92 in the EVSE 40 is configured to activate during a grid outage and provide a reference voltage and frequency signal on the AC bus 18. The inverter 92 may be powered by an auxiliary EVSE battery or by energy available on the AC line when islanded generation (e.g., from the PV system 50) is sufficient. The inverter 92 may operate independently of or in coordination with the grid-forming inverter 76 of the EV 42. In some embodiments, only one inverter is active at a time; in other embodiments, both inverters may cooperate to provide grid-forming capability.

The relay contactor 94 is positioned within the EVSE 40 to selectively connect or isolate the power path between the AC bus 18 and the power converter 96. The contactor 94 may be controlled by the EVSE controller 98 based on operating mode, voltage presence, or coordination signals received from the main controller 30 or the vehicle controller 82. During grid outages, the contactor 94 may remain open until a valid grid-forming reference is available on the AC bus 18, at which point the contactor 94 may close to initiate PV-based charging of the EV 42. In other embodiments, the contactor 94 may disconnect the power path when inverter-generated voltage is not within acceptable limits or when fault conditions are detected. The contactor 94 thereby supports selective engagement of the EV 42 in grid-forming or charging operations, and may be used to coordinate transitions between grid-connected and islanded operation.

The power converter 96 receives AC power from the AC bus 18 and converts it to DC power suitable for charging the traction battery 70. The power converter 96 may include a rectifier stage, a DC-DC converter stage, and associated control electronics for controlling voltage and current during charging. In grid-connected mode, the power converter 96 may operate based on line voltage supplied by the grid 22. During grid outages, the power converter 96 may instead operate based on voltage generated by a grid-forming inverter, such as inverter 76 in the EV 42 or inverter 92 in the EVSE 40. The power converter 96 may include internal logic or may operate under the supervision of the EVSE controller 98 to determine whether AC input parameters are within acceptable limits for charging. In some embodiments, the power converter 96 may incorporate input filtering, isolation transformers, or protection circuitry to support bidirectional power handling or to comply with applicable standards. The ability of the power converter 96 to operate from grid-forming AC sources allows the EVSE 40 to support photovoltaic-based charging of the EV 42 even in the absence of utility grid power.

The EVSE controller 98 manages communication with the vehicle controller 82, including exchange of SOC data, current limits, and charging enablement signals. The EVSE controller 98 may support analog signaling protocols such as control pilot (CP) and proximity pilot (PP), as well as digital communication protocols including power line communication (PLC), CAN-based messaging, or wireless communication links. The EVSE controller 98 may monitor real-time battery SOC data received from the vehicle controller 82 and determine whether conditions are appropriate to initiate or suspend charging. The EVSE controller 98 may also receive charge acceptance limits from the EV 42 and apply those constraints when configuring the power converter 96. In embodiments that include a grid-forming inverter 92 within the EVSE 40, the EVSE controller 98 may further coordinate inverter activation based on vehicle connection status, grid availability, or commands received from the main controller 30. The EVSE controller 98 may determine whether to activate the grid-forming inverter 92 during a grid outage, and whether to enable downstream charging based on availability of PV-generated energy on the AC bus 18. The EVSE controller 98 may also initiate grid-forming shutdown or transition back to grid-following operation upon detection of utility grid restoration. In some embodiments, the EVSE controller 98 may act as a supervisory interface, coordinating timing, control handoffs, and operating limits across the EVSE 40, EV 42, PV system 50, and the main controller 30 to support responsive system-wide energy management during both grid-connected and islanded operation.

The EVSE controller 98 may also receive or transmit control commands to the main controller 30 of the AC coupled system 10. This allows coordinated charging based on the availability of PV power or user-defined thresholds. In one implementation, the EVSE controller 98 delays charging until sufficient PV output is detected or until the SOC of the traction battery 70 falls below a lower limit. The EVSE 40 may include sensors to detect voltage and frequency on the AC bus 18 and may selectively activate the grid-forming inverter 92 based on those measurements. The EVSE controller 98 may also initiate shutdown of inverter operation when utility grid 22 power is restored and the system 10 re-enters grid-connected mode.

In various embodiments, the components of the EVSE 40—such as the vehicle interface 90, grid-forming inverter 92, relay contactor 94, power converter 96, and EVSE controller 98—may be housed within a common enclosure 100 to form a self-contained unit. The housing 100 may include internal mounting structures, thermal management elements, and electrical isolation barriers to accommodate high-and low-voltage components. In some implementations, all of components 90-98 are enclosed in a single unit that is mounted to a wall, pedestal, or integrated into a vehicle charging station enclosure. In other embodiments, one or more of components 90-98 may be physically separated from the others and located in a distinct housing for reasons such as thermal partitioning, spatial constraints, retrofit compatibility, or electromagnetic isolation. The housings may be connected via signal and power harnesses and may function cooperatively under the control of the EVSE controller 98 or another supervisory unit.

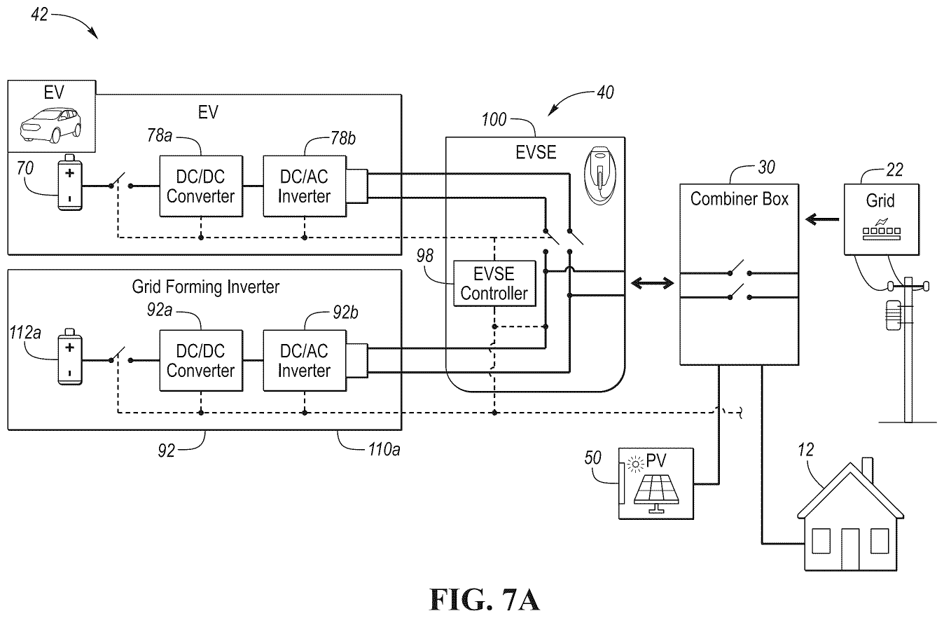

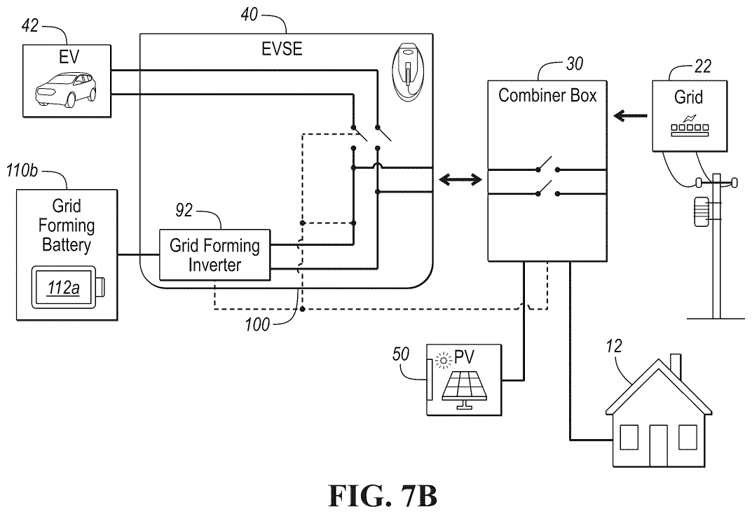

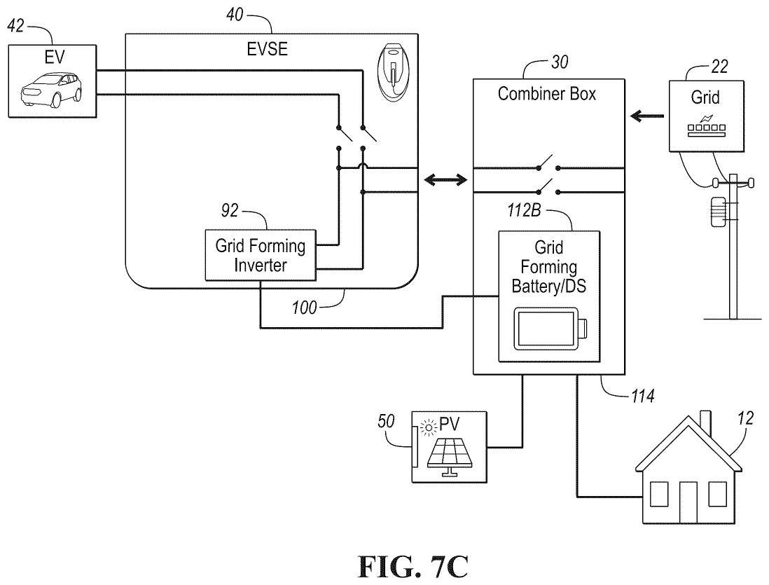

For example, referring to FIG. 7A, the EVSE controller 98 along with various other components—such as the vehicle interface 90, relay contactor 94, and power converter 96—are contained within the main EVSE housing 100. The grid-forming inverter 92, however, is located in a separate housing 110a external to the EVSE housing 100. The external housing 110a may include mounting and shielding structures tailored to the power and thermal requirements of the inverter 92. This arrangement may be beneficial in systems where the inverter 92 generates significant heat, requires additional clearance, or must be isolated from the control and communication electronics of the EVSE controller 98. The inverter 92 may be electrically and communicatively coupled to components within housing 100 through high-current wiring and signal cabling, allowing the EVSE controller 98 to coordinate grid-forming behavior without requiring co-location of all hardware elements.

As shown in FIG. 7A, the inverter 92 includes a DC/DC converter 92a and a DC/AC inverter 92b. The DC/DC converter 92a is configured to draw DC power from a grid-forming battery 112a that is co-located within the same external housing 110a. The converter 92a may include voltage management, current control, and pre-charge circuitry to condition power delivery to the inverter stage 92b. The DC/AC inverter 92b is configured to generate a grid-forming AC output, which may serve as the reference voltage and frequency signal needed to energize the AC bus and enable PV inverter operation during a grid outage. The inverter 92b may synchronize its output with internal control logic of the EVSE controller 98 or main controller 30, and may be selectively enabled based on grid presence, PV availability, or EV charging demand. Co-locating the grid-forming battery 112a and inverter 92 in a dedicated enclosure may provide integrated thermal management, reduce high-current cabling between battery and inverter, and allow the inverter assembly to be positioned independently of the EVSE housing 100 for modular installation.

Referring to FIG. 7B, another embodiment is shown in which the grid-forming inverter 92 is located within the EVSE housing 100, while the grid-forming battery 112a is stored in a physically separate external enclosure 110b. The inverter 92 receives high-voltage DC input from the remotely located battery 112a via shielded conductors and may include circuitry for detecting voltage presence, managing inrush current, and isolating fault conditions. Separating the battery 112a from the inverter 92 may allow the battery to be placed in an enclosure and/or location, or allow for battery upgrades without accessing the EVSE hardware. This configuration also supports space-constrained EVSE enclosures by offloading the bulk and thermal load of the battery to a more flexible external location.

Referring to FIG. 7C, yet another embodiment is illustrated in which the grid-forming inverter 92 is located within the EVSE housing 100 and receives power from a combined, dual-purpose grid-forming battery and dark start battery 112b. The combined battery 112b is housed within (or proximate and electrically connected to) the main controller enclosure 114, which also connects to the PV system 50 and home 12. The battery 112b includes internal voltage rails or circuits that support both high-voltage output for grid-forming and low-voltage output for dark start operations. As described above with respect to main controller 30, the dark start function includes energizing relays, initiating inverter startup sequences, and supporting logic circuits during transitions to islanded operation. The inverter 92 interfaces with the combined battery 112b via a power line routed from the controller housing 114 to the EVSE housing 100. This arrangement may allow a single, centralized battery pack to serve multiple distributed components in the home energy system.

While the embodiments described above illustrate the use of a single grid-forming inverter (e.g., GFI 60 in system 10, GFI 92 in EVSE 40, or GFI 76 in EV 42), it is contemplated that a residential or commercial environment may include more than one grid-forming inverter operating within the same energy system. For example, a home energy system may include a GFI integrated into the system 10, while an EVSE 40 with its own grid-forming capability is also installed on-site, and an electric vehicle 42 capable of grid-forming operation is connected to that EVSE 40. In such configurations, coordination between the various inverters may be provided such that only one GFI is actively forming the grid at a given time, or that multiple GFIs operate in a compatible, coordinated manner.

In one embodiment, the main controller 30 serves as a supervisory controller for managing grid-forming behavior across all components in the system 10. Upon detecting a grid outage, the main controller 30 may evaluate the status and availability of each grid-forming inverter in the system—such as GFI 60, GFI 92, and GFI 76—and select one to serve as the primary source of the reference voltage and frequency. The selection may be based on predefined priorities, inverter readiness, battery state-of-charge, thermal state, or recent operating history. For example, if the EV 42 is unplugged or below a minimum SOC threshold, the main controller 30 may disable the inverter 76 and activate the inverter 92 or 60 instead. This arbitration may be implemented through direct command signaling or through local inverter decision logic that responds to status broadcasts from the main controller 30.

In another embodiment, the GFIs may be configured for mutual exclusion, wherein each inverter monitors the AC bus 18 for an existing voltage and frequency signal before attempting to initiate grid-forming behavior. If a GFI detects a valid waveform already present—indicating that another inverter is already active—it remains in a passive or standby state. Only if no reference voltage is detected does the inverter proceed to engage its grid-forming mode. This approach prevents waveform overlap and permits autonomous inverter operation without requiring centralized arbitration, although coordination timing may be managed to introduce randomized or staggered startup windows to reduce conflict probability.

In certain implementations, two or more grid-forming inverters may operate concurrently in a synchronized manner, such as in split-phase systems with parallel inverter architectures. In such cases, the GFIs may be coupled via a communication interface (wired or wireless) and employ shared timing, phase-lock loop synchronization, or droop control strategies to maintain phase alignment and load sharing. This configuration may allow for seamless transitions between grid-connected and islanded operation, dynamic adjustment of inverter participation, or enhanced resiliency through inverter redundancy. Each inverter may report real-time operating parameters to the main controller 30 or to a distributed control mesh, enabling system-wide coordination and fault tolerance.

In still other embodiments, the inverter selection or coordination logic may reside within the EVSE controller 98 or the vehicle controller 82. For example, if the EVSE 40 detects that the system 10 is grid-isolated and no reference signal is present, it may activate its own grid-forming inverter 92. If the EVSE controller 98 subsequently receives a signal from the main controller 30 indicating that another GFI is now active, it may deactivate inverter 92 and resume grid-following behavior. Similarly, the vehicle controller 82 may suppress activation of the inverter 76 if it determines that a stable AC waveform is already present at the charging interface 72. This decentralized arbitration model allows each device to manage its own state based on locally detected or received information, without requiring persistent coordination through a master controller.

As discussed, a residential energy system may provide for bidirectional energy flow between an EV 42 and a PV system 50. Through intermediary components such as EVSE 40, a grid-forming inverter, and the AC bus 18, the EV 42 may assist in reestablishing power conditions that allow PV generation to resume and may then draw that energy for vehicle charging. Charging of the EV 42 may be subject to decision logic informed by system status, PV output, and the EV's traction battery 70 state of charge (SOC). Coordination among controllers (e.g., main controller 30, EVSE controller 98, or vehicle controller 82) helps evaluate these factors and determine when to initiate or suspend charging or inverter operation.

SOC values are used to guide whether the EV 42 engages in grid-forming behavior or draws charge from the PV system. In some configurations, SOC falling below a lower threshold (e.g., 30%) may lead the system to prevent activating the vehicle's inverter 76 or defer charging altogether. An upper threshold (e.g., 60%) may indicate when PV charging becomes favorable if generation is sufficient. These SOC boundaries may be preset, user-adjustable, or determined dynamically based on solar conditions, vehicle load, or utility preferences.

The control system may implement a sequencing routine during grid outages. The inverter designated for grid-forming becomes active first, followed by closure of the NFT relay 16 to establish a grounded neutral reference. Once a valid waveform is present, the PV inverter 52 resumes power delivery. At that point, the system considers SOC, PV output, and home demand before enabling EV charging. In systems with more than one available inverter, the main controller 30 may use predefined priority or real-time availability to determine which inverter engages. Alternatively, distributed logic may allow each inverter to sense bus conditions and activate accordingly if no competing source is active.

Upon grid restoration, the system transitions back by disabling PV injection, ramping down the active inverter, opening the NFT relay, and reestablishing connection to the utility via the main breaker 20. Throughout these operating states, the EV 42 remains capable of enabling PV operation, accepting solar charge, or yielding grid-forming responsibility based on control signals, SOC data, and load conditions.

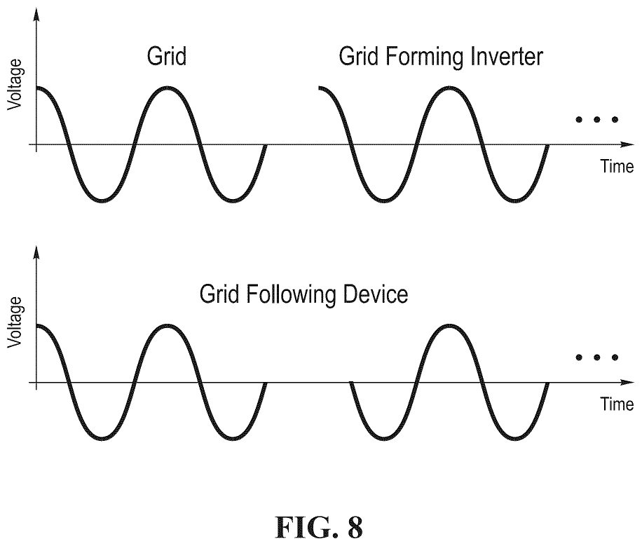

Referring to FIG. 8, waveforms on a distribution line are shown versus time. Initially, grid power is available and thus an AC waveform therefrom is shown. This waveform, however, terminates as grid power becomes unavailable. A grid-forming waveform generated by a grid-forming inverter, such as those contemplated herein, then appears on the distribution line to permit other grid-following devices to synchronize thereto.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. An apparatus comprising:
a home energy management system including a grid-forming inverter configured to be electrically connected to a grid and an inverter through a distribution line, and a controller programmed to activate the grid-forming inverter responsive to a loss of power from the grid on the distribution line such that the grid-forming inverter generates a grid-forming signal on the distribution line and the inverter, when connected with the grid-forming inverter via the distribution line, synchronizes to the grid-forming signal and delivers power to the distribution line.

2. The apparatus of claim 1, wherein the grid-forming signal has a reference voltage and frequency.

3. The apparatus of claim 1, wherein the grid-forming inverter is electrically connected to the distribution line upstream of a relay associated with a neutral-forming transformer.

4. The apparatus of claim 1, wherein the home energy management system further includes a neutral-forming transformer and a relay and wherein the grid-forming inverter is configured to generate the grid-forming signal independently of a state of the relay.

5. The apparatus of claim 1, wherein the home energy management system further includes a housing and wherein the grid-forming inverter is disposed within the housing.

6. The apparatus of claim 1, wherein the home energy management system further includes a housing, wherein the controller is disposed within the housing, and wherein the grid-forming inverter is disposed outside the housing.

7. The apparatus of claim 1 further comprising a battery configured to supply DC power to the grid-forming inverter.

8. The apparatus of claim 7, wherein the battery is a dark start battery.

9. The apparatus of claim 7, wherein the battery is disposed within a common enclosure with the grid-forming inverter.

10. The apparatus of claim 7, wherein the battery is disposed within a common enclosure with the controller that is separate from the grid-forming inverter.

11. The apparatus of claim 1, wherein the inverter is a photo voltaic inverter or a vehicle inverter.

12. A method comprising:
activating a grid-forming inverter of a home energy management system responsive to loss of grid power such that the grid-forming inverter, using power from a dark start battery of the home energy management system, generates a grid-forming signal on a distribution line.

13. The method of claim 12 further comprising closing a relay to engage a neutral-forming transformer of the home energy management system after the activating.

14. The method of claim 12 further comprising deactivating the grid-forming inverter responsive to restoration of the grid power.

15. A home energy system comprising:
a grid-forming inverter configured to be electrically connected with a photovoltaic system via a distribution line; and
a controller programmed to activate the grid-forming inverter responsive to a loss of grid power on the distribution line, wherein the grid-forming inverter is further configured to generate a grid-forming signal on the distribution line and wherein the photovoltaic system is configured to synchronize to the grid-forming signal and deliver power to the distribution line.

16. The home energy system of claim 15 further comprising a neutral forming transformer, wherein the controller is further programmed to engage the neutral forming transformer while the grid-forming inverter is generating the grid-forming signal.

17. The home energy system of claim 15 further comprising a battery configured to supply DC power to the grid-forming inverter.

18. The home energy system of claim 17, wherein the battery is a dark start battery.
